(19) United States
(12) Patent Application Publication
(10) Pub. No.: US 2009/0315683 A1
(43) Pub. Date: Dec. 24, 2009

(54) Analog RFID System

(75) Inventor: John R. TUTTLE, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: KEYSTONE TECHNOLOGY SOLUTIONS, LLC, Boise, ID (US)

(21) Appl. No.: 12/144,762

(22) Filed: Jun. 24, 2008

(51) Int. Cl. H04B 7/00

(52) U.S. Cl. 340/10.4

(57) ABSTRACT

Methods and apparatus, including computer program products, for an analog RFID system. A radio frequency identification (RFID) device includes an antenna linked to an integrated circuit, the integrated circuit comprising tag circuitry and analog modulation circuitry, a device linked to the integrated circuit, the device generating an analog signal output, and the analog modulation circuitry configured to conditioning the analog signal output.

### BACKGROUND

The present invention relates to radio frequency identification (RFID), and more particularly to an analog RFID system.

RFID is a technology that incorporates the use of electromagnetic or electrostatic coupling in the radio frequency (RF) portion of the electromagnetic spectrum to uniquely identify an object, animal, or person. With RFID, the electromagnetic or electrostatic coupling in the RF (radio frequency) portion of the electromagnetic spectrum is used to transmit signals. A typical RFID system includes an antenna and a transceiver, which reads the radio frequency and transfers the information to a processing device (reader) and a transponder, or RF tag, which contains the RF circuitry and information to be transmitted. The antenna enables the integrated circuit to transmit its information to the reader that converts the radio waves reflected back from the RFID tag into digital information that can then be passed on to computers that can analyze the data.

RFID systems have been used for transmitting digital data in payload packets.

### SUMMARY

The present invention provides methods and apparatus, including computer program products, for an analog RFID system.

In one aspect, the invention features a radio frequency identification (RFID) device including an antenna linked to an integrated circuit, the integrated circuit including tag circuitry and analog modulation circuitry, a device linked to the integrated circuit, the device generating an analog signal output, and the analog modulation circuitry adapted to condition the analog signal output.

In another aspect, the invention features a system including a radio frequency identification (RFID) reader adapted to transmit a continuous wave un-modulated radio frequency (RF) signal and receive a signal in response, the transmitted signal including one or more commands, the commands including one or more parameters, a radio frequency identification (RFID) device configured to respond to the transmitted RF signal, the RFID device including an antenna linked to an integrated circuit, the integrated circuit comprising tag circuitry and analog modulation circuitry, a device linked to the integrated circuit, the device generating an analog signal output, and the analog modulation circuitry adapted to condition the analog signal output.

In another aspect, the invention features a method including transmitting a radio frequency identification (RFID) reader analog read/control command from a RFID reader to a RFID tag, receiving the RFID reader analog read/control command in the RFID tag, executing control instructions in the RFID tag in response to the command, conditioning an analog data stream received by the RFID tag from an analog device, and sending the modulated analog data stream to the RFID reader.

Other features and advantages of the invention are apparent from the following description, and from the claims.

### BRIEF DESCRIPTION OF THE DRAWINGS

FIG. 1 is a block diagram of an exemplary radio frequency identification (RFID) system.

FIG. 2 is a block diagram of a RFID tag.

FIGS. 3A and 3B are exemplary graphs.

FIG. 4 is a flow diagram of a process.

Like reference numbers and designations in the various drawings indicate like elements.

### DETAILED DESCRIPTION

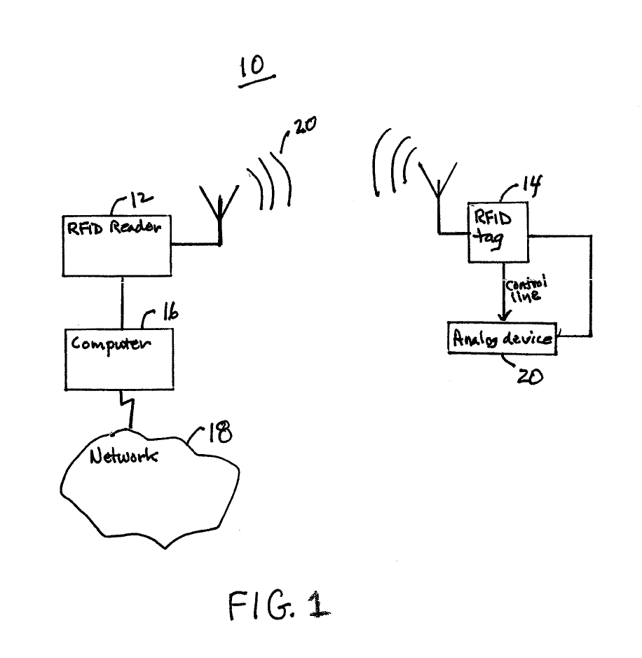

As shown in FIG. 1, an exemplary radio frequency identification (RFID) system 10 includes a RFID interrogator (also referred to as a reader) 12 and a RFID tag 14 (as referred to as a label or device). In this RFID system 10, the RFID interrogator 12 is controlled by a computer 16, whether internal or external, and the computer 16 is connected to a network 18. In RFID system 10, the RFID tag 14 communicates to the RFID interrogator 12 using backscatter. More specifically, RFID interrogator 12 sends a radio signal 20 using a frequency protocol sometimes referred to as an air-interface protocol.

The RFID tag 14 is linked to a device 20. Although the device 20 is shown as being external to the RFID tag 14, in other examples the device 20 can be embedded into the RFID tag 14. Historically, when analog output from device 20 is transmitted to a RFID reader from the RFID tag, the analog data is first converted to numbers in the RFID tag 14 using, for example, an Analog-to-Digital Converter (ADC), and only then transmitted to the RFID reader as part of a packet of digital numbers.

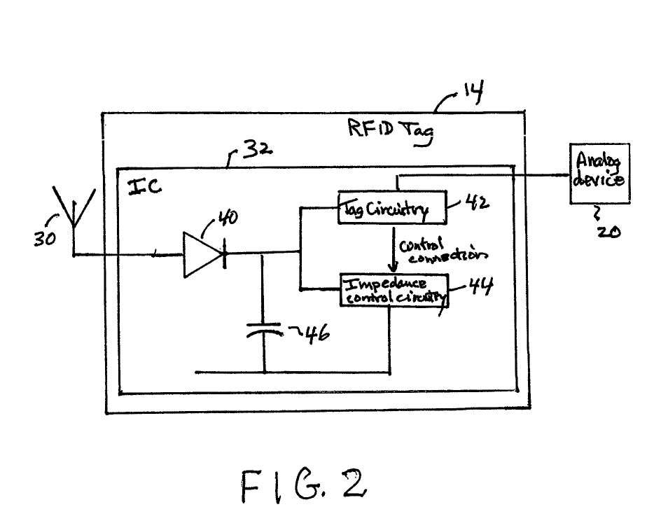

As shown in FIG. 2, the RFID tag 14 includes an antenna 30 linked to an integrated circuit 32. The integrated circuit 32 is linked to the device 20 to receive the device's 20 output. The device 20 generates an analog output signal that is received by the RFID tag 14.

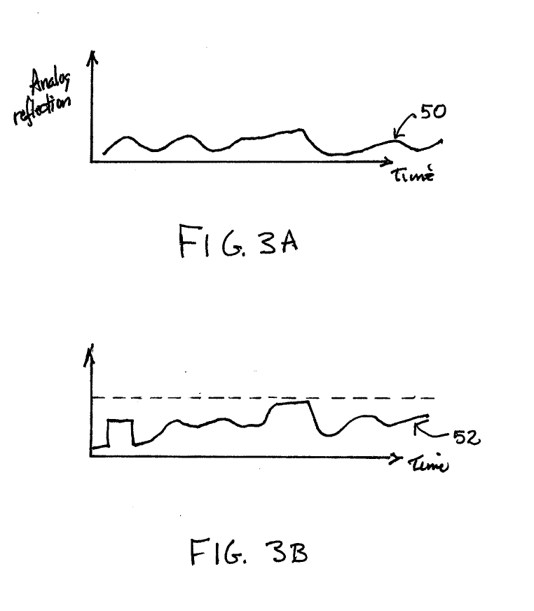

The integrated circuit 32 includes a diode 40, tag circuitry 42, analog modulation (or impedance control) circuitry 44 and a power supply 46. Tag circuitry 42 delivers the received analog signal to the antenna 30 after conditioning by analog modulation circuitry 44. The output of the analog modulation circuitry 44 is routed to the antenna from which power is transmitted or reflected to the RFID reader 12. Here the impedance control circuit 44 modulates the antenna feedpoint impedance in an analog fashion, with infinitely variable states between maxima and minima. FIG. 3A is a plot of an exemplary analog output signal 50. FIG. 3B illustrates an exemplary signal 52 having a min/max that can be used to calibrate the analog output signal 50 of FIG. 3A. However, any type of analog modulation can be used, such AM, FM, Phase, I & Q Pulse Position and Single Sideband Modulation (SSB), or combinations thereof.

In other examples, the reader 12 can issue a command to the RFID tag 14 to start the analog tag transmission, which may then transmit for the length of time indicated by a parameter within the command. Also, a command can contain one or more control parameters, such as a control parameter for turning a device on, and may contain related commands, such as for device timing and amplitude.

In other examples, a RFID tag can have multiple analog devices and/or digital devices attached. RFID reader command parameters may include control parameters for multiple devices attached to the RFID tag, from which analog data transmission will ensue.

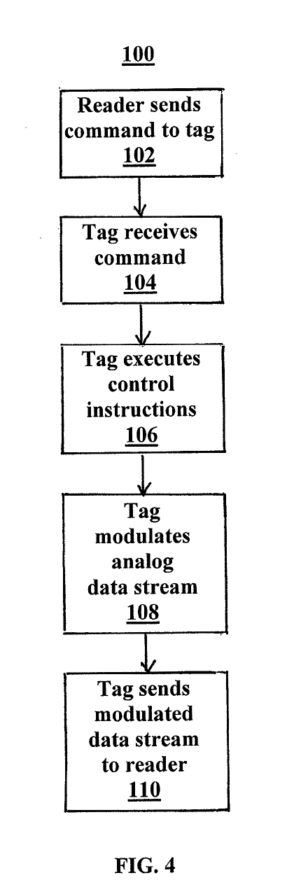

As shown in FIG. 4, a RFID process 100 includes sending (102) a RFID reader analog read/control command to a RFID tag. The RFID tag receives (104) the RFID reader analog read/control command from the RFID reader. The RFID tag executes (106) control instructions in response to the command. The RFID tag modulates (108) a analog data stream and sends (110) it to an antenna.

In one aspect, the present invention enables the gathering and delivering of large quantities of data with one or few commands to small memory RFID tags. The present invention relates to using RFID systems for transmitting data in an analog manner from any source accessible by the RFID tag, such as from an output of an instrument or instrument transducers with analog or digital outputs.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A radio frequency identification (RFID) device comprising:
an antenna linked to an integrated circuit, the integrated circuit comprising tag circuitry and analog modulation circuitry;
a device linked to the integrated circuit, the device generating an analog signal output; and
the analog modulation circuitry configured to condition the analog signal output.

2. The RFID device of claim 1 wherein the conditioning comprises modulating antenna feed point impedance in an analog fashion with infinitely variable states between maxima and minima.

3. The RFID device of claim 1 wherein the analog modulation circuitry includes one of a AM, FM, Phase I, I & Q Pulse Position, Position and Single Sideband Modulation (SSB) or combination thereof.

4. The RFID device of claim 1 wherein the tag circuitry is configured to receive one or more commands from a RFID reader and execute instructions in response to the one or more commands.

5. The RFID device of claim 4 wherein the one or more commands include an instruction to start transmitting analog data from the device.

6. The RFID device of claim 4 wherein the one or more commands include one or more control parameters, the control parameters including a parameter to turn the device on, turn the device off, and/or set device timing and amplitude.

7. The RFID device of claim 1 further comprising one or more additional devices linked to the integrated circuit, each of the one or more additional device generating an analog signal output.

8. A system comprising:
a radio frequency identification (RFID) reader configured to transmit a continuous wave un-modulated radio frequency (RF) signal and receive a signal in response, the transmitted signal including one or more commands, the commands including one or more parameters;
a radio frequency identification (RFID) device configured to respond to the transmitted RF signal, the RFID device comprising:
an antenna linked to an integrated circuit, the integrated circuit comprising tag circuitry and analog modulation circuitry;
a device linked to the integrated circuit, the device generating an analog signal output; and
the analog modulation circuitry configured to condition the analog signal output.

9. The system of claim 8 wherein the conditioning comprises modulating antenna feed point impedance in an analog fashion with infinitely variable states between maxima and minima.

10. The system of claim 8 wherein the analog modulation circuitry includes one of a AM, FM, Phase I, I & Q Pulse Position, Position and Single Sideband Modulation (SSB) or combination thereof.

11. The system of claim 8 wherein the tag circuitry is adapted receive the one or more commands from the RFID reader and execute instructions in response to the one or more commands.

12. The system of claim 11 wherein the one or more commands include an instruction to start transmitting analog data from the device.

13. The system of claim 11 wherein the control parameters include a parameter to turn the device on, turn the device off, and/or set device timing and amplitude.

14. The system of claim 8 further comprising one or more additional devices linked to the integrated circuit, each of the one or more additional device generating an analog signal output.

15. A method comprising:
transmitting a radio frequency identification (RFID) reader analog read/control command from a RFID reader to a RFID tag;
receiving the RFID reader analog read/control command in the RFID tag;
executing control instructions in the RFID tag in response to the command;
conditioning an analog data stream received by the RFID tag from an analog device; and
sending the modulated analog data stream to the RFID reader.

16. The method of claim 15 wherein conditioning comprises modulating antenna feed point impedance in an analog fashion with infinitely variable states between maxima and minima.

17. The method of claim 15 wherein the command includes an instruction to start transmitting analog data from the analog device.

18. The method of claim 15 wherein the command includes one or more control parameters, the control parameters including a parameter to turn the device on, turn the device off, and/or set device timing and amplitude.
